(19) United States
(12) Patent Application Publication
(10) Pub. No.: US 2011/0155950 A1
(43) Pub. Date: Jun. 30, 2011

(54) PROCESS FOR THE PREPARATION OF 4-BROMOPHENYL DERIVATIVES

(75) Inventors: Andreas Lindenmaier, Steinen (DE); Martin Vogt, Mannheim (DE); Gerhard Beck, Rheinfelden (DE); Achim Bührer, Grenzach-Wyhlen (DE)

(73) Assignee: BASF SE, LUDWIGSHAFEN (DE)

(21) Appl. No.: 13/056,692

(22) PCT Filed: Jul. 30, 2009
(86) PCT No.: PCT/EP09/59854

§ 371 Date: Mar. 18, 2011

(30) Foreign Application Priority Data
Aug. 5, 2008 (EP) 08161774.8

(51) Int. Cl. C09K 3/00

(52) U.S. Cl. 252/182.12

(57) ABSTRACT

Disclosed is a process for the preparation of a mixture of 4-bromophenyl derivatives (compound of formula (2)) and 2,4-dibromophenyl derivatives (compound of formula (3)) comprising the steps of [1] reacting in a two-phase (liquid-liquid) system a bromide containing source with a phenyl derivative (formula (1)) in the presence of an excess of an oxidizing agent, an acid, and optionally a catalyst selected from vanadium pentoxide and ammonium heptamolybdate forming 4-bromo- (compound of formula (2)) and 2,4-dibromo derivatives (compound of formula (3)) and as intermediate product the 2-bromo derivative (compound of formula (4)) which reacts in step [2] to the 2,4-dibromo derivative (formula (3)) according to the following reaction scheme 2 wherein R₁ is hydroxy; C₁-C₅alkoxy; or —NR₂R₃; and R₂ and R₃ independently from each other are hydrogen; or C₁-C₅alkyl.

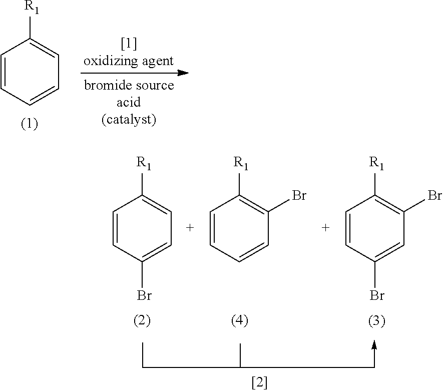

Bromide containing waste waters are formed in numerous chemical reactions, for example in Grignard reactions when the Grignard reagent R—Mg—Br (R=alkyl, aryl, or heteroaryl) is used for the preparation of aryl- or alkyl substituted aryl or alkyl derivatives:

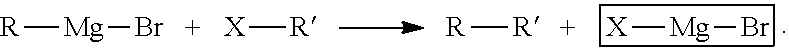

For example, Bromide containing waste water (MgBrCl) is formed in the process for the preparation of phenyl triazine intermediates (reaction scheme 1):

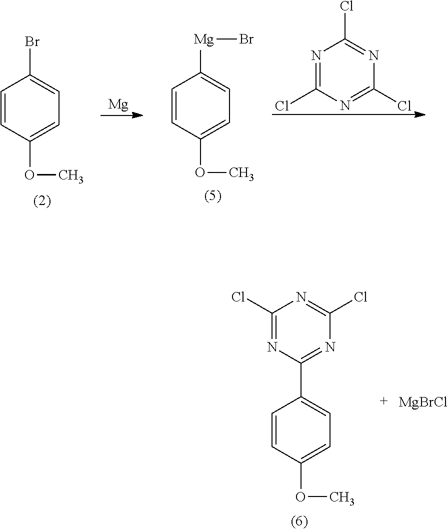

Bromide containing waste waters represent an environmental risk and public administrations show a tendency to constrict the upper limits more and more.

Furthermore, bromine is an expensive chemical product and it is therefore a necessity to recycle the bromide in a chemical process.

Therefore a common interest exists to eliminate the bromide in the waste water or, alternatively, to recycle the substrate in the corresponding reaction process.

Surprisingly it was found that oxidation of the waste water from a Grignard reaction comprising magnesium bromide chloride or magnesium bromide gives in situ bromine.

Bromination of phenyl derivatives like phenol, bromoanisole or aniline will lead to 4-bromophenyl derivatives which can be returned in the above shown reaction process.

Therefore, the present invention relates to a process for the preparation of a mixture of 4-bromophenyl derivatives (compound of formula (2)) and 2,4-dibromophenyl derivatives (compound of formula (3)) comprising the steps of [1] reacting in a two-phase (liquid-liquid) system a bromide containing source with a phenyl derivative (formula (1)) in the presence of an excess of an oxidizing agent, an acid, and optionally a catalyst selected from vanadium pentoxide and ammonium heptamolybdate forming 4-bromo- (compound of formula (2)) and 2,4-dibromo derivatives (compound of formula (3)) and as intermediate product the 2-bromo derivative (compound of formula (4)) which reacts in step [2] to the 2,4-dibromo derivative (formula (3)) according to the following reaction scheme 2:

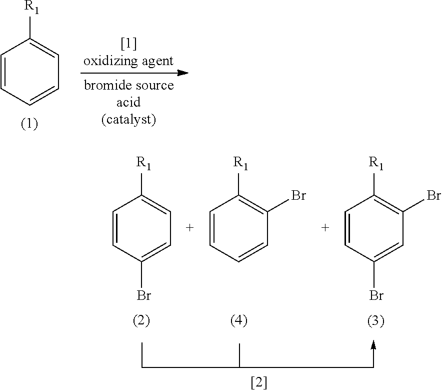

wherein
R₁ is hydroxy; C₁-C₅alkoxy; or —NR₂R₃; and
R₂ and R₃ independently from each other are hydrogen; or C₁-C₅alkyl.

In a preferred embodiment the process according to the present invention comprises the steps of reacting in a two-phase system a bromide containing source with a phenyl derivative (formula (1)) according to the following reaction scheme 3:

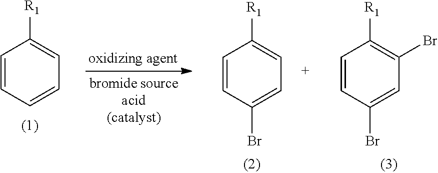

wherein
R₁ is defined as in reaction scheme 2.

R₁ is preferably C₁-C₅alkoxy and most preferably methoxy.

In the reaction above the yield of the 4-bromoanisole (compound (2); R₁=methoxy) is from 75 to 90, preferably >80% and the yield of 2,4-dibromoanisole is from 5 to 25%, preferably <15%, 2-bromoanisole is from 0 to 4%, preferably <0.5%.

The amount of bromide source used in the present invention is from 90 to 150, preferably >110%.

Examples for the oxidation agents are H₂O₂ and NaOCl in a wide concentration range, for example 30, 35 or 50% (H₂O₂) and 14% (NaOCl).

Hydrogen peroxide is preferably used.

The oxidizing agent is used in amounts from 84 to 150%, preferably >110%.

The bromide containing source is preferably selected from alkaline metal bromide salts, more preferably from NaBr, KBr or LiBr.

Furthermore, earth alkaline metal bromide salts can be used in the process of the present invention, preferably MgBr₂ or a mixed Mg salt (MgBrₓCl_{y}).

Most preferably the bromide containing source is a mixed Mg salt (MgBrₓCl_{y}).

MgBrₓCl_{y} is for example formed in the preparation of phenyltriazines intermediates according to the reaction scheme 1.

As catalysts ammoniumheptamolybdate tetrahydrate in a range of 0.0024 mol % to 1.4 mol % and vanadium pentoxide in a range of 0.4 mol % to 1.4 mol % is preferably used.

The acid used in the present preparation process is preferably selected from sulfuric acid and most preferably HCl.

The acid is preferably used in used in amounts of 0.6 to 3.5 equivalents, more preferably in amounts of 0.6 to 3.5 equivalents.

The reaction temperature the reaction temperature in step [1] and [2] is from 15 to 50° C.

Preferably, the reaction temperature in step [1] while charging with H₂O is from 15 to 30° C. and in the after-reaction step [2] from 25 to 50° C.

In the process of the present invention the 2-bromophenyl derivative is formed as a byproduct, however in a concentration of <0.5%.

There is a need for the chemical selectivity between the 4-bromophenyl derivative and 2-bromophenyl derivative because they have nearly the same boiling point. A separation of these products is not possible by rectification.

The preferred process according to the present invention leads to a good yield for 4-bromoanisole (and so less 2,4-dibromoanisole).

The yield of 4-bromoanisole is from 75 to 90 and the yield of 2,4-dibromoanisole is from 5 to 25%.

The hint of the synthesis is that in a “first” [1] reaction the anisole is converted to the bromoanisoles (typically ˜85-90% 4-bromoanisole, 2.5-4% 2-bromoanisole and 6.5-12.5% 2,4-dibromoanisole). This reaction is finished depending on the amount of catalyst in 10 min to 3 hours.

Then in a “second” [2] reaction the monobromoanisoles are converted to 2,4-dibromoanisole. That sequence needs between 30 min up to 2 days till all 2-bromoanisole is reacted to 2,4-dibromoanisole. If the amount of hydrogen peroxide, bromide, reaction time, reaction temperature or catalyst is too low this “second” [2] reaction doesn't occur.

The benefits of the present invention are the recycling of bromide not only for the ecological reasons but also because bromide is not cheap.

The compounds of formula (5) are important intermediates for the preparation of organic UV absorbers, especially hydroxyphenyl triazines (HPT). These compounds are useful UV absorbers for cosmetic and technical applications.

For example, the compound of formula (5) is used for the preparation of Bis-Ethylhexyloxyphenol Methoxyphenyl Triazine as described in EP 0 775 698.

In the following Example the process of the present invention is described without limiting it.

### PREPARATION EXAMPLES

### Example 1

In a 1 l vessel the bromide containing waste water (0.49 mol bromide) is mixed with anisole (54.1 g, 0.50 mol), hydrochloric acid (60.4 g, 0.53 mol, 32% in water) and vanadium pentoxide (1.3 g, 0.007 mol). Hydrogen peroxide (68.0 g, 0.60 mol, 30% in water) is added at 20° C. over a period of 35 min to this reaction mixture. After 5 h stirring at ambient temperature the phases are separated to yield in 90.0 g of the crude material containing 4-bromoanisole and 2,4-dibromoanisole.

### Example 2

In a 1 l vessel the bromide containing waste water (0.60 mol bromide) is mixed with anisole (54.1 g, 0.50 mol), hydrochloric acid (60.4 g, 0.53 mol, 32% in water) and vanadium pentoxide (1.3 g, 0.007 mol). Hydrogen peroxide (68.0 g, 0.60 mol, 30% in water) is added at 20° C. over a period of 40 min to this reaction mixture. After 5.5 h stirring at ambient temperature the phases are separated to yield in 101.0 g of the crude material containing 4-bromoanisole and 2,4-dibromoanisole.

### Example 3

In a 1 l vessel the bromide containing waste water (0.56 mol bromide) is mixed with anisole (54.1 g, 0.50 mol) and hydrochloric acid (57.0 g, 0.50 mol, 32% in water). Hydrogen peroxide (66.9 g, 0.59 mol, 30% in water) is added at 20° C. over a period of 5 h to this reaction mixture. After 24 h stirring at ambient temperature the phases are separated to yield in 89.5 g of the crude material containing a mixture of 4-bromoanisole, 2,4-dibromoanisole and less than 1% of 2-bromoanisole.

### Example 4

In a 2.5 l vessel the bromide containing waste water (2.8 mol bromide) are mixed with anisole (270.5 g, 2.5 mol), hydrochloric acid (285.0 g, 2.5 mol, 32% in water) and ammonium heptamolybdate tetrahydrate (75 mg, 0.06 mmol).

Hydrogen peroxide (0.30 l, 2.95 mol; 30% in water) is added at 20° C. over a period of 5 h to this reaction mixture.

After 18 h stirring at ambient temperature the excess of hydrogen peroxide is destroyed by addition of 50 ml sodium hydrogen sulfite solution (40% in water; test for peroxides afterwards negative).

After phase separation the aqueous solution phase is extracted with 0.301 toluene.

The combined organic phases are washed with sodium hydrogen carbonate solution.

The toluene and remaining water are distilled off (azeotropic).

Rectification under vacuum (50 mbar, 110-112° C.) furnished 4-bromoanisole (379 g, 81%).

The residue (98 g) contains a mixture of 4-bromoanisole and 2,4-dibromoanisole.

Process Control is done with GC, qualitative and quantitative.

### Alternatives to Work-Up Procedure:

The peroxides may be destroyed by addition of sodium sulfite (20 g), by addition of sodium hydrogen sulfite (50 ml) or simply by heating up to 40° C. for some time.
Washing for the organic phases with sodium hydrogen carbonate for neutralization is possible.

### Example 5

In a 1 l vessel the bromide containing waste water (0.75 mol bromide) is mixed with anisole (54.1 g, 0.50 mol), hydrochloric acid (57.0 g, 0.50 mol, 32% in water) and vanadium pentoxide (1.3 g, 0.007 mol). Hydrogen peroxide (66.9 g, 0.59 mol, 30% in water) is added at 20° C. over a period of 30 min to this reaction mixture. After 18 h stirring at ambient temperature the phases are separated to yield in 64.0 g of the crude material containing 4-bromoanisole and 2,4-dibromoanisole.

### Example 6

In a 1 l vessel the bromide containing waste water (0.56 mol bromide) is mixed with anisole (54.1 g, 0.50 mol), hydrochloric acid (57.0 g, 0.50 mol, 32% in water) and ammonium heptamolybdate tetrahydrate (0.15 g, 0.116 mmol). Hydrogen peroxide (66.9 g, 0.59 mol, 30% in water) is added at 20° C. over a period of 5 h to this reaction mixture. After 18 h stirring at ambient temperature the phases are separated to yield in 84.5 g of the crude material containing 4-bromoanisole and 2,4-dibromoanisole.

### Example 7

In a 1 l vessel the bromide containing waste water (0.60 mol bromide) is mixed with anisole (54.1 g, 0.50 mol), hydrochloric acid (60.4 g, 0.53 mol, 32% in water) and vanadium pentoxide (1.3 g, 0.007 mol). Sodium hypochlorite (358.0 g, 0.70 mol, 14% in water) is added at 20° C. over a period of 1 h to this reaction mixture. After 22 h stirring at ambient temperature the phases are separated to yield in 83.0 g of the crude material containing 4-bromoanisole and 2,4-dibromoanisole.

### Example 8

In a 1 l vessel the bromide containing waste water (0.56 mol bromide) is mixed with anisole (54.1 g, 0.50 mol), hydrochloric acid (57.0 g, 0.50 mol, 32% in water) and ammonium heptamolybdate tetrahydrate (0.015 g, 0.0121 mmol). Hydrogen peroxide (66.9 g, 0.59 mol, 30% in water) is added at 20° C. over a period of 5 h to this reaction mixture. After 18 h stirring at ambient temperature the mixture is heated up to 40° C. for 1 h to destroy residues of peroxides in solution. The phases are separated to yield a crude mixture of 4-bromoanisole and 2,4-dibromoanisole and less than 0.2% 2-bromoanisole.

### Example 9

In a 1 l vessel the bromide containing waste water (0.56 mol bromide) is mixed with anisole (54.1 g, 0.50 mol), hydrochloric acid (171.0 g, 1.5 mol, 32% in water) and ammonium heptamolybdate tetrahydrat (0.015 g, 0.012 mmol). Hydrogen peroxide (64.6 g, 0.57 mol, 30% in water) is added at 20 to 25° C. over a period of about 5 hours to this reaction mixture. After approximately 17 hours stirring at ambient temperature the mixture is heated up to 40° C. for one hour. Afterwards the phases are separated to yield in 95.0 g of the crude material containing a mixture of 4-bromoanisole and 2,4-dibromoanisole. GC and NMR gives a ratio of 81 to 19. The content of 2-bromoanisole is below 0.2%. The mixture of 4-bromoanisole and 2,4-dibromoanisole might be separated via rectification under vacuum.

### Example 10

In a 1 l vessel the bromide containing waste water (0.56 mol bromide) is mixed with anisole (54.1 g, 0.50 mol), hydrochloric acid (171.0 g, 1.5 mol, 32% in water) and ammonium heptamolybdate tetrahydrat (0.015 g, 0.012 mmol). Hydrogen peroxide (64.6 g, 0.57 mol, 30% in water) is added at 20 to 25° C. over a period of about 5 hours to this reaction mixture. This mixture is stirred for another 1 hour at ambient temperature. Afterwards the whole mixture is heated up to 40° C. for another hour. Then the two phases are separated to yield in 90.5 g of the crude material containing a mixture of 4-bromoanisole and 2,4-dibromoanisole. GC and NMR gives a ratio of 83 to 17. The content of 2-bromoanisole is below 0.2%. The mixture of 4-bromoanisole and 2,4-dibromoanisole might be separated via rectification under vacuum.

### Example 11

In a 1 l vessel the bromide containing waste water (0.56 mol bromide) is mixed with anisole (54.1 g, 0.50 mol), hydrochloric acid (171.0 g, 1.5 mol, 32% in water) and ammonium heptamolybdate tetrahydrat (0.015 g, 0.012 mmol). Hydrogen peroxide (64.6 g, 0.57 mol, 30% in water) is added at 20 to 25° C. over a period of about 5 hours to this reaction mixture. This mixture is stirred for another 1 hour at ambient temperature. Afterwards the whole mixture is heated up to about 40° C. for 17 hours. Then the two phases are separated to yield in 91.0 g of the crude material containing a mixture of 4-bromoanisole and 2,4-dibromoanisole. GC and NMR gives a ratio of 83 to 17. The content of 2-bromoanisole is below 0.2%. Yield is calculated from this data to 83% 4-bromonisole and 12% 2,4-dibromoanisole. The mixture of 4-bromoanisole and 2,4-dibromoanisole might be separated via rectification under vacuum.

### Example 12

In a 2.5 l vessel the bromide containing waste water (2.13 mol bromide) is mixed with anisole (208 g, 1.90 mol), hydrochloric acid (660 g, 5.70 mol, 32% in water) and ammonium heptamolybdate tetrahydrat (0.06 g, 0.05 mmol). Hydrogen peroxide (149 g, 2.17 mol, 30% in water) is added at 18 to 25° C. over a period of about 5 hours to this reaction mixture. This mixture is stirred for another 1 hour at ambient temperature. Afterwards the whole mixture is heated up to about 40° C. for another hour. Then the two phases are separated to yield in 373 g of the crude material containing a mixture of 4-bromoanisole and 2,4-dibromoanisole. GC and NMR gives a ratio of about 81 to 19. The content of 2-bromoanisole is <0.2%. The mixture of 4-bromoanisole and 2,4-dibromoanisole might be separated via rectification under vacuum.

### Example 13

In a 1 l vessel the bromide containing waste water (0.84 mol bromide) is mixed with phenol (79.1 g, 0.84 mol), hydrochloric acid (95.7 g, 0.84 mol, 32% in water) and ammonium heptamolybdate tetrahydrat (0.050 g, 0.04 mmol). Hydrogen peroxide (100.4 g, 0.88 mol, 30% in water) is added at 20 to 25° C. over a period of about 5 hours to this reaction mixture. After approximately 17 hours stirring at ambient temperature the phases are separated to yield in 148.1 g of the crude material. GC analysis reveals three peaks in the chromatogram: 2-bromophenol, 4-bromophenol and 2,4-dibromophenol. Main product with ˜79% (Area) was the 4-bromophenol. The structures are confirmed by NMR analysis of this mixture.

### Example 14

In a 1 l vessel the bromide containing waste water (0.84 mol bromide) is mixed with phenol (20.0 g, 0.21 mol), hydrochloric acid (95.7 g, 0.84 mol, 32% in water) and ammonium heptamolybdate tetrahydrat (0.050 g, 0.04 mmol). Hydrogen peroxide (100.4 g, 0.88 mol, 30% in water) is added at 20 to 25° C. over a period of about 5 hours to this reaction mixture. After addition of half of the hydrogen peroxide a yellow-orange precipitate was formed. After approximately 17 hours stirring at ambient temperature this precipitate is filtered off. 74.9 g of dry product was isolated. GC and NMR showed one single compound: 2,4,6-Tribromophenol.

### Example 15

In a 1 l vessel the bromide containing waste water (0.79 mol bromide) is mixed with ethylphenylether (96.7 g, 0.79 mol), hydrochloric acid (90.0 g, 0.79 mol, 32% in water) and ammonium heptamolybdate tetrahydrat (0.050 g, 0.04 mmol). Hydrogen peroxide (100.4 g, 0.88 mol, 30% in water) is added at 20 to 25° C. over a period of about 5 hours to this reaction mixture. After approximately 17 hours stirring at ambient temperature the phases are separated to yield in 133.4 g of the crude material. GC analysis reveals three major peaks in the chromatogram: Ethyl-2-bromophenylether, Ethyl-4-bromophenylether, Ethyl-2,4-dibromophenylether. Main product is the Ethyl-4-bromophenylether with 92.3% (Area). The structures are confirmed by NMR analysis of this mixture.

### Example 16

In a 1 l vessel the bromide containing waste water (0.84 mol bromide) is mixed with toluene (77.4 g, 0.84 mol), hydrochloric acid (95.5 g, 0.84 mol, 32% in water) and ammonium heptamolybdate tetrahydrat (0.025 g, 0.018 mmol). Hydrogen peroxide (100.4 g, 0.88 mol, 30% in water) is added at 20 to 25° C. over a period of about 5 hours to this reaction mixture. After approximately 17 hours stirring at ambient temperature the phases are separated to yield in 105.0 g of the crude material. GC analysis reveals four major peaks in the chromatogram: Toluene, 2-bromotoluene, 4-bromotoluene, 2,4-dibromotoluene and benzylbromide. Main products are 4-bromotoluene 31.7% (Area) and benzylbromide 30.1% (Area). The structures are confirmed by NMR analysis of this mixture.

1. Process for the preparation of a mixture of 4-bromophenyl derivatives (compound of formula (2)) and 2,4-dibromophenyl derivatives (compound of formula (3)) comprising the steps of [1] reacting in a two-phase (liquid-liquid) system a bromide containing source with a phenyl derivative (formula (1)) in the presence of an excess of an oxidizing agent, an acid, and optionally a catalyst selected from vanadium pentoxide and ammonium heptamolybdate forming 4-bromo- (compound of formula (2)) and 2,4-dibromo derivatives (compound of formula (3)) and as intermediate product the 2-bromo derivative (compound of formula (4)) which reacts in step [2] to the 2,4-dibromo derivative (formula (3)) according to the following reaction scheme 2: 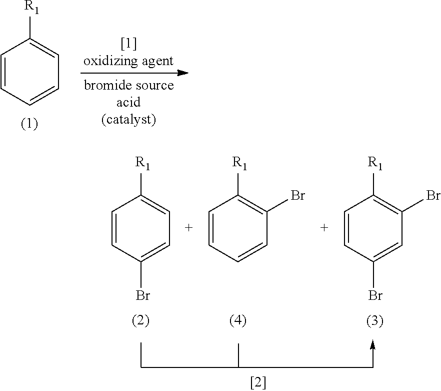
wherein
R₁ is hydroxy; C₁-C₅alkoxy; or —NR₂R₃; and
R₂ and R₃ independently from each other are hydrogen; or C₁-C₅alkyl.

2. Process according to claim 1, comprising the steps of reacting in a two-phase system a bromide containing source with a phenyl derivative (formula (1)) in the presence of an excess of an oxidizing agent, an acid, and optionally a catalyst selected from vanadium pentoxide and ammonium heptamolybdate according to the following reaction scheme 3: 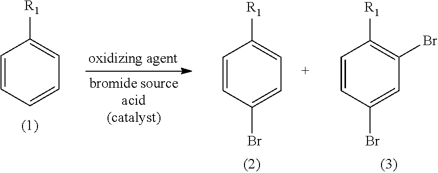
wherein
R₁ is defined as in claim 1.

3. Process according to claim 1, wherein
R₁ is C₁-C₅alkoxy.

4. Process according to claim 1, wherein
R₁ is methoxy.

5. Process according claim 4, wherein the yield of 4-bromoanisole is from 75 to 90 and the yield of 2,4-dibromoanisole is from 5 to 25%.

6. Process according to claim 1, wherein the oxidizing agent is selected from H₂O₂ and NaOCl.

7. Process according to claim 6, wherein the oxidizing agent is H₂O₂.

8. Process according to claim 1, wherein the oxidizing agent is used in amounts from 84 to 150%.

9. Process according to claim 1, wherein the bromide containing source is selected from alkaline metal bromide salts.

10. Process according to claim 9, wherein the bromide containing source is selected from NaBr, KBr and LiBr.

11. Process according to claim 1, wherein the bromide containing source is selected from earth alkaline metal bromide salts.

12. Process according to any of claims 11, wherein the bromide containing source is selected from MgBr₂ and mixed Mg salts (MgBrₓCl_{y}).

13. Process according to claim 11, wherein the bromide containing source is a mixed Mg salt (MgBrₓCl_{y}).

14. Process according to claim 9, wherein the bromide containing source is used in amounts of 90 to 150%.

15. Process according to claim 1, wherein the acid is selected from HCl and sulfuric acid.

16. Process according to claim 15, wherein the acid is HCl.

17. Process according to claim 15, wherein the acid is used in amounts of 0.6 to 3.5 equivalents.

18. Process according to claim 1, wherein the reaction temperature in step [1] and [2] is from 15 to 50° C.

19. Process according to claim 1, wherein the reaction temperature in step [1] is from 15 to 30° C. and in step [2] from 25 to 50° C.

20. (canceled)
